(19) United States
(12) Patent Application Publication
(10) Pub. No.: US 2004/0045398 A1
(43) Pub. Date: Mar. 11, 2004

(54) Damper

(75) Inventor: Ken Hayashi, Aichi-ken (JP)

Correspondence Address: KANESAKA AND TAKEUCHI, Suite 2, 1423 Powhatan Street, Alexandria, VA, 22314, US

(73) Assignee: NIFCO INC.

(21) Appl. No.: 10/449,594

(22) Filed: Jun. 2, 2003

(30) Foreign Application Priority Data
Sep. 9, 2002 (JP) 2002-262250

(51) Int. Cl. F16F 15/10

(52) U.S. Cl. 74/574

(57) ABSTRACT

A damper includes a housing having a substantially cylindrical shape and filled with viscous fluid; a rotor portion rotatably supported inside the housing; fin portions projecting from the rotor portion; and deformable portions provided in the fin portions for changing a clearance between an end of the fin portion and an inner peripheral surface of the housing in response to resistance received\ed from the viscous fluid. The deformable portion is provided in the fin portion to allow the fin portion to deform elastically in response to the resistance received from the viscous fluid, and to change the clearance between the end of the fin portion and the inner peripheral surface of the housing.

### BACKGROUND OF THE INVENTION AND RELATED ART STATEMENT

The present invention relates to a rotary damper used for a glove box, ashtray, and the like in an automobile.

As shown in FIG. 8, a conventional rotary damper used for a glove box, ashtray, and the likes in an automobile includes a cylindrical case 100 filled with viscous fluid such as silicone oil; a cover member (not shown in the figure) for closing the case 100; and a rotor 102 supported on an axis for rotating inside the case 100.

The rotor 102 is composed of a cylindrical shaft 104 and multiple fin portions 106 projecting from an outer peripheral face of the shaft 104. One end side of the shaft 104 is exposed from the case 100, and connected to a braking member (for example, a cover member of the glove box, etc.) requiring braking force.

Since the viscous fluid is filled inside of the case 100, when the shaft 104 is rotated, viscous torque by the viscous fluid is generated on the fin portions 106. The braking force acts on the braking member through the fin portions 106 and the shaft 104, and the braking member moves slowly.

A certain type of rotary damper is designed to generate the braking force in only one direction so that when the braking member such as a cover member is opened, the cover member is slowly opened due to the braking force, and when the cover member is closed, the cover member is easily closed with little braking force.

For example, Japanese Patent Publication (Tokkai) No. 06-2727 has disclosed a damper in which an axis of a rotor stored inside a case is shifted off an axis of the case. Further, fin portions are attached to the rotor in a state where the fin portions are inclined in one way and able to swing, so that the fin portions slide against an inner wall of the case. When the rotor rotates in a direction opposite to the inclined direction of the fin portions, the fin portions swing to open and rotate while sliding against the inner wall of the opening case. Accordingly, a space inside the case between the fin portions gradually increases, thereby increasing the viscous torque due to the viscous fluid and the braking force. When the rotor rotates in the same direction as the inclined direction of the fin portions, the fin portions swing to close. Thus, the viscous fluid does not generate a large amount of the viscous torque, thereby generating little the braking force on the rotor.

However, in the rotary damper described above, the viscous fluid such as silicone oil is used to generate the braking force. Accordingly, there is a large difference in the viscous torque between summer and winter, that is, a viscosity becomes low in summer and the viscous torque on the fin portion decreases.

The present invention has been made in view of the problem described above, and an object of the present invention is to provide a damper having a small temperature dependency.

Further objects and advantages of the invention will be apparent from the following description of the invention.

### SUMMARY OF THE INVENTION

According to the present invention, a damper includes: a housing having a substantially cylindrical shape and filled with viscous fluid; a rotor portion supported on a shaft to be rotatable inside the housing; fin portions projecting from the rotor portion; and deformable portions provided in the fin portions for changing a clearance between an end of the fin portion and an inner peripheral surface of the housing in response to resistance received from the viscous fluid.

In the present invention, the deformable portion is provided in the fin portion to allow the fin portion to deform elastically in response to the resistance received from the viscous fluid, and to change the clearance between the end of the fin portion and the inner peripheral surface of the housing.

The viscous torque generated at the end of the fin portion depends on a flow volume of the viscous fluid passing through the clearance between the end of the fin portion and the inner peripheral surface of the housing. When the clearance becomes larger, the viscous torque due to the flow volume of the viscous fluid (hereinafter referred to as “first viscous torque”) at the end of the fin portion is decreased.

The viscous fluid has a viscosity higher in winter than in summer. Thus, the viscous torque due to the viscosity of the viscous fluid (hereinafter referred to as “second viscous torque”) at the end of the fin portion is increased in winter. Accordingly, the fin portion elastically deforms in a larger extent.

In other words, when the viscosity is increased, the second viscous torque is increased at the end of the fin portion. At this time, the fin portion elastically deforms in a larger extent, so that the clearance between the end of the fin portion and the inner peripheral surface of the housing is increased to decrease the first viscous torque at the end of the fin portion. As a result, both effects are offset each other, and total viscous torque is maintained almost constant.

When the viscosity becomes low in a high temperature such as summer, the second viscous torque at the end of the fin portion becomes small as compared to a situation in a low temperature such as winter. As a result, the fin portion elastically deforms in a smaller extent, so that the clearance between the end of the fin portion and the inner peripheral surface of the housing is decreased to increase the first viscous torque.

In other words, when the viscosity is low, the clearance between the end of the fin portion and the inner peripheral surface of the housing is decreased to increase the first viscous torque at the end of the fin portion. As a result, the decline in the viscous torque due to the decline of the viscosity is offset.

With this configuration, the clearance between the end of the fin portion and the inner peripheral surface of the housing is adjustable according to the resistance received from the viscous fluid depending on the viscosity. Thus, the changes in the viscous torque are offset, so that the damper has a small temperature dependency.

In the invention, the deformable portion may be formed in a narrow portion at a side of the rotor portion. With the narrowed portion, the fin portion elastically deforms easily.

In the invention, the deformable portion may be formed in a leaf spring connecting the rotor portion and the fin portion. With the leaf spring, the fin portion elastically deforms easily. The leaf spring may be molded with insert molding. With the insert molding, it is not necessary to attach the leaf spring and the fin portion to the rotor portion, thereby reducing manpower for an operation and a cost.

The end of the fin portion may be formed in an arc shape having a curvature radius smaller than an inside diameter of the inner peripheral surface of the housing. The curvature radius of the arc is gradually decreasing toward outside from the center of the end of the fin portion. With this configuration, when the fin portion elastically deforms, the end of the fin portion does not abut against the inner peripheral surface of the housing. Further, it is possible to increase the clearance between the end of the fin portion and the inner peripheral surface of the housing according to the elastic deformation of the fin portion.

It is possible to provide projections projecting in the axial direction of the rotor portion on top and bottom faces at the end of the fin portion. With this configuration, the second viscous torque at the end of the fin portion can be increased, so that the fin portion elastically deforms easily.

According to another aspect of the present invention, a damper includes a housing having a substantially cylindrical shape and filled with viscous fluid; a rotor portion supported on a shaft to be rotatable inside the housing; fin portions projecting from the rotor portion; and extension portions extending from one side from a centerline of the fin portion for changing a clearance between an end of the fin portion and the inner peripheral surface of the housing according to a rotational direction of the shaft.

The extension portion extends to one side from the centerline of the fin portion, so that the clearance between the end of the extension portion and the inner peripheral surface of the housing is changed according to the rotational direction of the rotor portion. Thus, it is possible, for example, to decrease the clearance in one rotational direction to increase the braking force, and to increase the clearance in the other rotational direction to reduce the braking force (so-called one-way damper).

In the damper described above, it is possible to provide projections projecting in the axial direction of the rotor portion on top and bottom faces of the end of the extension portion. With this configuration, it is possible to increase the second viscous torque at the end of the extension portion, so that the fin portion elastically deforms easily.

### BRIEF DESCRIPTION OF THE DRAWINGS

FIG. 1 is an exploded perspective view showing a configuration of a damper according to the first embodiment of the present invention;

FIG. 2 is a sectional view showing the damper according to the first embodiment of the present invention;

FIG. 3 is a plan view showing the damper according to the first embodiment of the present invention;

FIG. 4 is an operational view showing a state where fin portion in the damper of the first embodiment of the present invention deforms elastically;

FIG. 5 is an operational view showing a state where fin portion in the damper of the second embodiment of the present invention deforms elastically;

FIG. 6 is an operational view showing a state where the fin portion in the damper of the second embodiment of the present invention deforms elastically;

FIG. 7 is an explanatory view of a modified example of a fin portion of the invention; and

FIG. 8 is an exploded perspective view showing a configuration of a conventional damper.

### DETAILED DESCRIPTION OF PREFERRED EMBODIMENTS

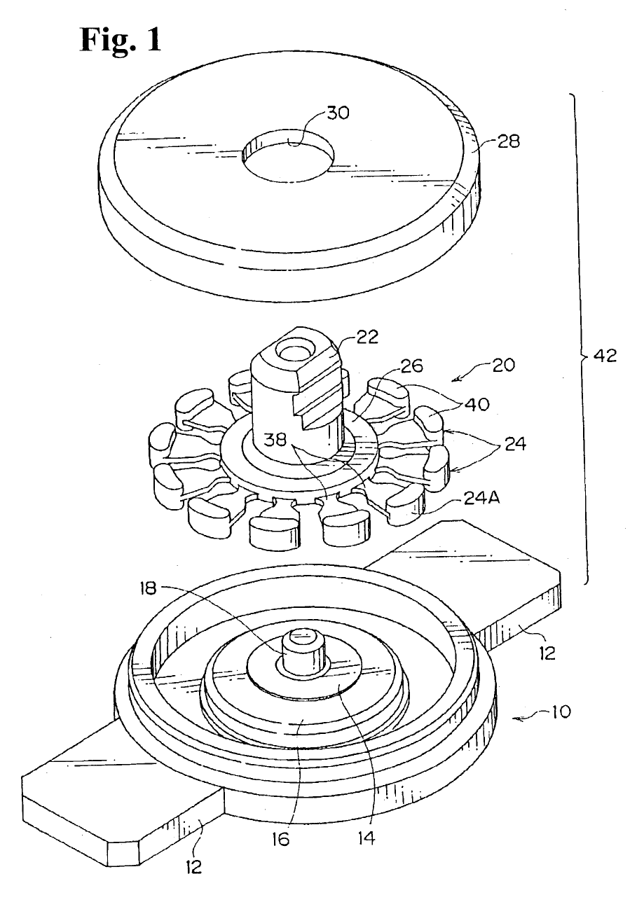

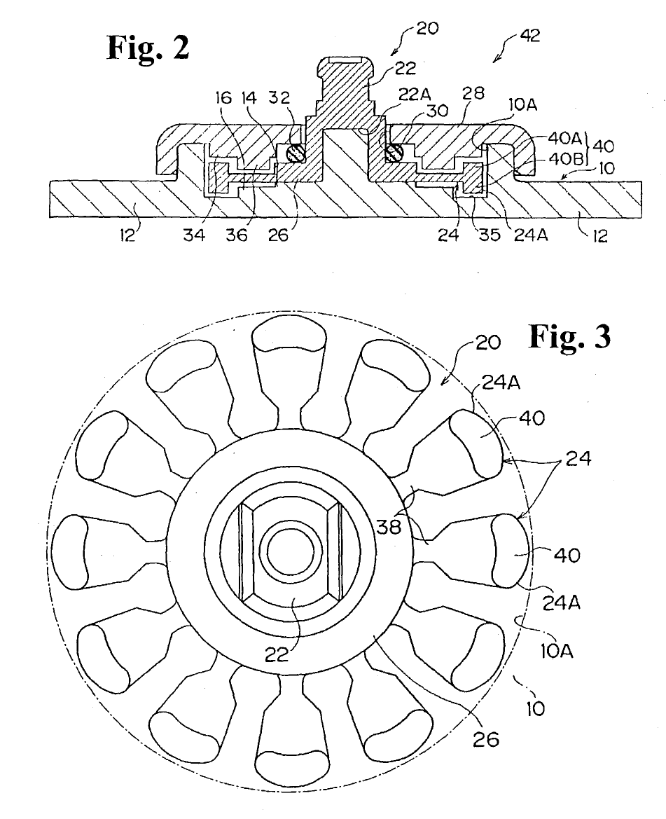

Hereunder, embodiments of the present invention will be explained with reference to the accompanying drawings. As shown in FIGS. 1 and 2, a pair of fixed pieces 12 extends from an outer peripheral wall of a housing 10 having a substantially cylindrical shape with a bottom. The fixed pieces 12 have backsides flash with a backside of the housing 10. A small diameter stage 14 and a large diameter stage 16 are coaxially formed at an axial part of the housing 10, and the small diameter stage 14 is located on a top surface of the large diameter stage 16.

A fixed shaft 18 having a cylindrical shape projects at a central part of the small diameter stage 14. The fixed shaft 18 is arranged to support a rotor portion 20 to be stored inside the housing 10. The rotor portion 20 is formed of a shaft 22 and fin portions 24. An engagement depression 22A is formed at one end side of the shaft 22, and the engagement depression 22A has an inside diameter slightly larger than an outside diameter of the fixed shaft 18. The engagement depression 22A engages the fixed shaft 18, so that the rotor portion 20 rotates relative to the housing 10.

A pedestal or base 26 having a ring shape is formed in the shaft 22, and projects from an outer peripheral face at an end of the shaft 22. A plurality of fin portions 24 projects radially from an outer peripheral face of the pedestal 26. The fin portion 24 has a thickness thinner than that of the pedestal 26, and has a backside flash with that of the pedestal 26.

The housing 10 is filled with viscous fluid, and a cover member 28 having a substantially cylindrical shape closes the housing 10. The cover member 28 has an inside diameter of an inner peripheral surface same as an outside diameter of an outer peripheral surface of the housing 10. The cover member 28 is welded and fixed to the housing 10 by ultrasonic welding.

A through-hole 30 is formed at an axis part of the cover member 28 for receiving the other end side of the shaft 22. A seal ring 32 is fitted in the outer peripheral face of the shaft 22 for sealing the housing 10 to prevent the viscous fluid inside the housing 10 from leaking.

A large diameter stage 34 and a small diameter stage 36 having ring shapes project from the backside of the cover member 28, and the small diameter stage 36 is located on the large diameter stage 34. A space is provided between an outer peripheral surface of the large diameter stage 34 and an inner peripheral surface 10A of the housing 10. When the viscous fluid filled inside the housing 10 is expanded due to a temperature change, the space can absorb an excess volume.

As shown in FIG. 3, the fin portion 24 is disposed horizontally parallel to a bottom face of the housing 10. A narrowed portion 38 having a narrow width is formed at a base side of the fin portion 24. As shown in FIGS. 2 and 3, a projection 40 is provided at an end of the fin portion 24, and projects from top and bottom surfaces of the fin portion 24 in an axial direction of the shaft 22. An arc face 24A is formed at the end of the fin portion 24, and faces an inner peripheral surface 10A of the housing 10.

When the arc face 24A is located at a position closest to the inner peripheral surface 10A of the housing 10, there is an approximately 0.05 mm clearance between the arc face 24A and the inner peripheral surface 10A of the housing 10.

The arc face 24A has a curvature radius smaller than an inside diameter of the inner peripheral surface 10A of the housing 10, and the curvature radius of the arc faces 24A gradually decreases toward outside from the center of the fin portion 24.

The pedestal 26 is placed on the small diameter stage 14. The pedestal 26 has an outside diameter roughly the same as that of the small diameter stage 14. A space is provided between the large diameter stage 16 and the fin portion 24. A projection 40B of the fin portion 24 is placed in a groove portion 35 composed of an outer peripheral surface of the large diameter stage 16 and the inner peripheral surface of the housing 10, and there is a space between the projection 40B and the bottom face of the groove portion 35.

The small diameter stage 36 projecting from the backside of the cover member 28 is located at a position facing the large diameter stage 16 of the housing 10 in a state that the housing 10 is closed. Also, the large diameter stage 16 is located at a position facing the groove portion 35 of the housing 10.

A space is provided between a top surface of the fin portion 24 and the small diameter stage 36 of the cover member 28. This space is roughly the same as a space between a back surface of the fin portion 24 and the large diameter stage 16 of the housing 10. Also, a space is provided between the projection 40A of the fin portion 24 and the large diameter stage 34 of the cover member 28, and this space is roughly the same as the space between the projection 40B of the fin portion 24 and the groove portion 35 of the housing 10. With this configuration, the fin portions 24 receive the viscous torque balanced in the vertical direction, so that the fin portions 24 do not vibrate when moving in the viscous fluid.

A distance between the small diameter stage 36 of the cover member 28 and the large diameter stage 16 of the housing 10 is smaller than a distance between the large diameter stage 34 of the cover member 28 and the groove portion 35 of the housing 10. Thus, the viscous fluid flows easily at a side of the projections 40 of the fin portions 24.

In the damper 42 having the above configuration, the fixed pieces 12 are fixed to, for example, a main member of a glove box (not shown), to attach the damper 42 to the main member of the glove box. In this state, a pinion (not shown) is attached to the other end (a portion exposed from the cover member 28) of the shaft 22, and a gear is attached to a cover portion of the glove box for engaging the pinion. When the cover portion is moved, the movement is transmitted to the pinion through the gear to rotate the shaft 22. At this time, the fin portions 24 stir the viscous fluid, thereby generating the viscous torque at the projections 40 of the fin portions 24, and applying the braking force on the shaft 22 through the fin portions 24. Accordingly, the braking force is applied on the cover portion through the pinion and the gear, so that the cover portion opens slowly.

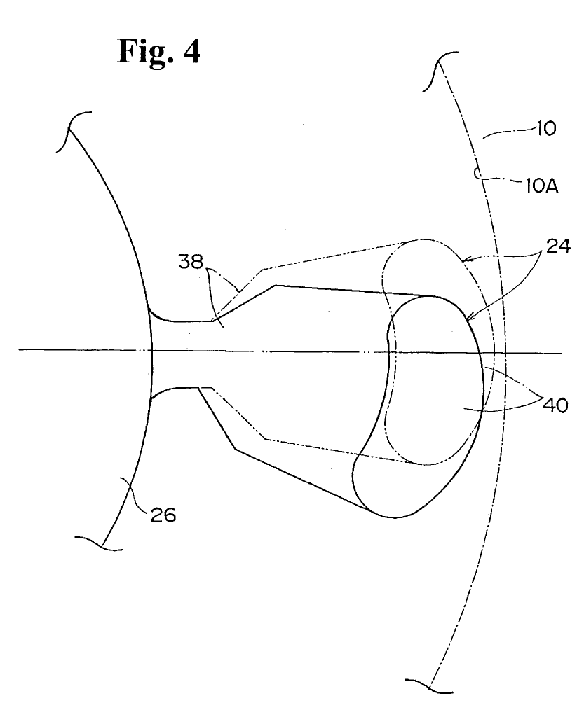

Next, a damper effect of the present embodiment will be explained. As shown in FIGS. 3 and 4, the narrowed portion 38 with a narrow width is formed at the base side of fin portion 24, so that the fin portion 24 elastically deforms easily according to resistance received from the viscous fluid. Also, it is possible to change the clearance between the arc face 24A of the fin portion 24 and the inner peripheral surface 10A of the housing 10 (hereinafter referred to as simply clearance) when the arc face 24A of the fin portion 24 is located at a position closest to the inner peripheral surface 10A of the housing 10.

The viscous fluid has a viscosity in winter higher than in summer, so that the viscous torque due to the viscosity of the viscous fluid (hereinafter referred to as “second viscous torque”) at the projections 40 of the fin portions 24 is increased in winter, and the fin portions 24 elastically deform in a larger extent.

In other words, when the viscosity is increased, the second viscous torque at the projections 40 of the fin portions 24 is increased. At the same time, the fin portions 24 elastically deform in a larger extent to increase the clearance between the arc face 24A of the fin portion 24 and the inner peripheral surface 10A of the housing, thereby decreasing the viscous torque due to viscous flow of the viscous fluid (hereinafter referred to as “first viscous torque”) at the projections 40 of the fin portions 24. Therefore, the increment in the second viscous torque is offset by the decline in the first viscous torque.

When the viscosity becomes lower in a high temperature such as in summer, the second viscous torque at the projections 40 of the fin portions 24 is decreased as compared to the condition in winter, so that the fin portions 24 elastically deform in a smaller extent. Therefore, the clearance between the arc face 24A of the fin portion 24 and the inner peripheral surface 10A of the housing 10 is decreased to increase the first viscous torque.

In other words, when the viscosity becomes lower, the decline in the viscous torque part due to the decline in the viscosity is offset by the increment in the first viscous torque at the projections 40 of the fin portions 24 due to the increment in the clearance between the arc face 24A of the fin portion 24 and the inner peripheral surface 10A of the housing 10.

Accordingly, the clearance between the arc face 24A of the fin portion 24 and the inner peripheral surface 10A of the housing 10 is adjustable according to the resistance received from the viscous fluid depending on the viscosity. Therefore, the damper 42 has a low temperature dependency.

The arc face 24A of the fin portion 24 has the curvature radius smaller than the inside diameter of the inner peripheral surface 10A of the housing 10, and the curvature radius of the arc face 24A is gradually decreased toward outside from the center of the projection 40 of the fin portion 24. With this configuration, when the fin portion 24 elastically deforms, the arc face 24A of the fin portion 24 does not abut against the inner peripheral surface 10A of the housing 10. Also, it is possible to increase the clearance between the arc face 24A of the fin portion 24 and the inner peripheral surface 10A of the housing 10 according to the elastic deformation of the fin portion 24.

Furthermore, the projection 40 projecting in the axial direction of the rotor portion 20 is formed on the top and bottom faces at the end of the fin portion 24. Thus, the viscous torque at the end of the fin portion 24 is increased, and the fin portion 24 elastically deforms easily.

Next, a damper according to the second embodiment of the present invention will be explained. The explanation regarding components same as those in the first embodiment is omitted.

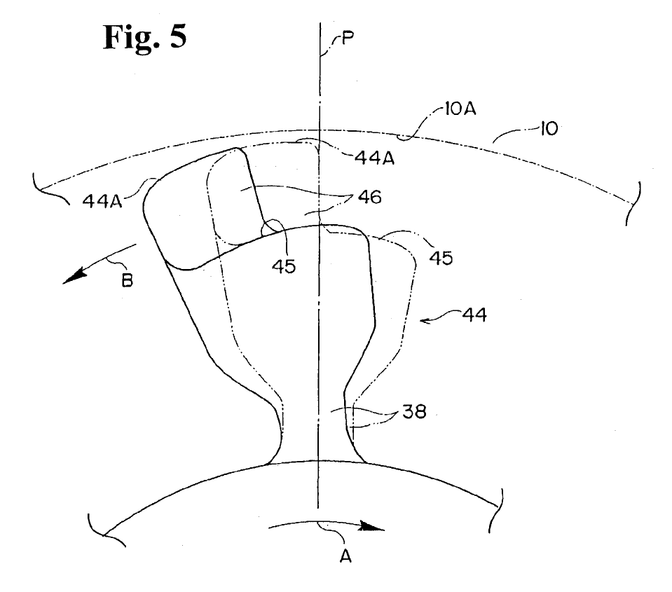

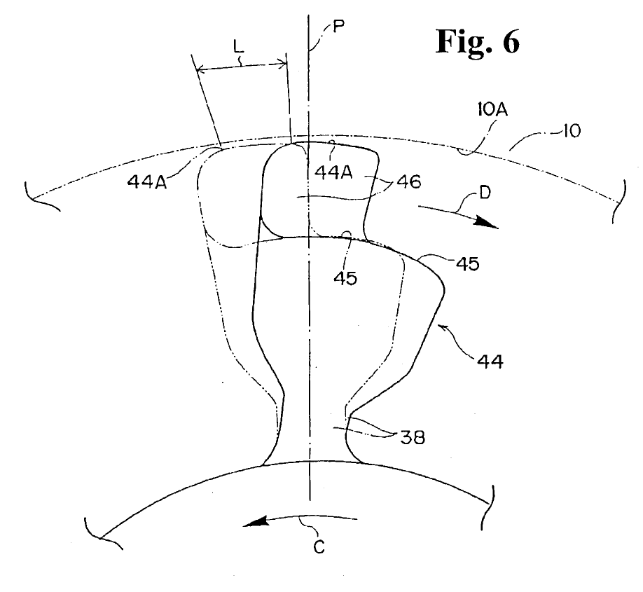

As shown in FIG. 5, a clearance between an end portion 45 of a plate-like fin portion 44 and an inner peripheral surface 10A of the housing 10 is increased. Also, an extension portion 46 is formed at a left side of a centerline P of the fin portion 44 in the figure, and projects from the end portion 45 of the fin portion 44.

In the extension portion 46, an arc face 44A is formed to face the inner peripheral surface 10A of the housing 10. The arc face 44A of the extension portion 46 is formed in an arc shape to have a center same as a rotational center when the fin portion 44 elastically deforms. There is an approximately 0.05 mm clearance between the arc face 44A and the inner peripheral surface 10A of the housing 10 when the arc face is located at a position closest to the inner peripheral surface (hereinafter referred to as “closest position”).

The extension portion 46 has corners having a small curvature radius. One of the corners located at a side of the centerline P of the fin portion 44 has a curvature radius smaller than that of the other of the corners, thereby minimizing the effect of the viscous torque at the extension portion 46 when rotation begins.

The closest position is located at a side of the centerline P of the fin portion 44. Accordingly, when the shaft 22 rotates in the arrow A direction and the fin portion 44 deforms in the arrow B direction by the resistance of the viscous fluid, the closest position of the arc face 44A moves in a direction away from the centerline P of the fin portion 44 before elastically deforms. Thus, the clearance between the arc face 44A of the extension portion 46 and the inner peripheral surface 10A of the housing 10 is gradually increased in proportion to the elastic deformation of the fin portion 44 to decrease the second viscous torque at the extension portion 46.

As shown in FIG. 6, when the shaft 22 is rotated in the arrow C direction (opposite to the arrow A direction), and the fin portion 44 deforms in the arrow D direction, the closest position of the arc face 44A passes the centerline P of the fin portion 44 before elastically deforms.

The fin portion 44 elastically deforms around the centerline P of the fin portion 44. Therefore, as long as the fin portion 44 elastically deforms (the fin portion 44 deforms by approximately 15 degrees in the drawing) within a range of an arc L of the arc face 44A of the extension portion 46 (a distance between the corners of the arc face 44A), the clearance between the inner peripheral surface 10A of the housing 10 is maintained at approximately 0.05 mm.

With the above-mentioned configuration, when the shaft 22 is rotated in the arrow C direction, the clearance between the arc face 44A of the extension portion 46 and the inner peripheral surface 10A of the housing 10 is maintained even if the fin portion 44 elastically deforms, thereby obtaining a predetermined braking force. When the shaft 22 is rotated in the direction opposite to the arrow C direction, the clearance between the arc face 44A of the extension portion 46 and the inner peripheral surface 10A of the housing 10 is increased due to the elastic deformation of the fin portion 44, thereby minimizing the braking force. Thus, the damper performs as a so-called one-way damper.

The damper of the present invention is not limited to the glove box, and can be used for a covering member of an AV instrument, or for a braking member moving horizontally such as an ashtray or cup holder placed inside a vehicle. At this time, a rack engaging a pinion is disposed in the ashtray or cup holder. The damper can be attached to the braking member as well.

In the embodiments, the fin portions are disposed in a horizontal position relative to the bottom face of the housing. Alternatively, the fin portions can be disposed in a vertical position relative to the bottom face of the housing, or in a declined position relative to the bottom face of the housing. The projection is provided at the end of the fin portion, but it is not necessary to provide the projection.

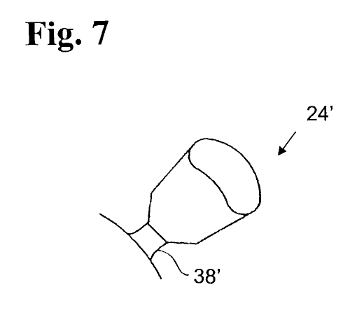

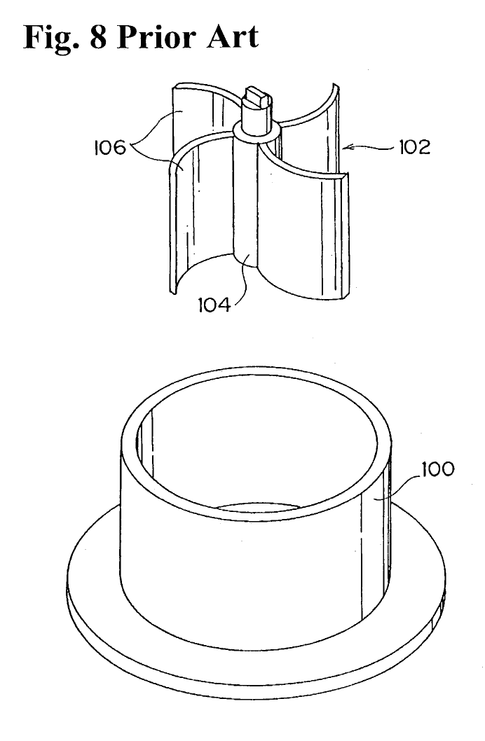

It is possible to form the shaft and fin portions as a unit, thereby reducing the steps for attaching the fin portions to the shaft and a cost. Alternatively, the narrowed portion is formed of a leaf spring 38′ as shown in FIG. 7, and the fin portion 24′ is connected to the shaft through the leaf spring 38′. In this case, the leaf spring can be formed as a unit with the shaft and fin portions by insert molding. With the insert molding, it is not necessary to attach the leaf spring and fin portions to the shaft, thereby reducing the manufacturing steps and the cost.

The clearance between the arc face of the fin portion and the inner peripheral surface of the housing is arranged to be 0.05 mm in the state where the fin portion does not elastically deform. The clearance can be modified according to the viscosity of the viscous fluid, or the shape of the fin portions.

In the present invention having the configuration mentioned above, the changes in the viscous torque are offset as the clearance between the end of the fin portion and the inner peripheral surface of the housing is adjusted according to the resistance received from the viscous fluid depending on the viscosity, so that the damper has a low temperature dependency.

In the present invention, the fin portion elastically deforms easily. It is not necessary to attach the leaf spring and fin portions to the rotor portion, thereby reducing the manpower and the cost.

When the fin portion elastically deforms, it is arranged that the end of the fin portion does not abut against the inner peripheral surface of the housing. Further, it is possible to increase the clearance between the end of the fin portion and the inner peripheral surface of the housing according to the elastic deformation of the fin portion. Also, it is possible to increase the viscous torque at the end of the fin portion.

In the damper of the invention, it is possible to generate the braking force in one direction by decreasing the clearance, and to minimize the braking force in the other direction by increasing the clearance.

While the invention has been explained with reference to the specific embodiments of the invention, the explanation is illustrative and the invention is limited only by the appended claims.

What is claimed is:

1. A damper, comprising:
a housing having a cylindrical shape and an inner peripheral surface,
viscous fluid filled in the housing,
a rotor portion rotatably supported inside the housing,
fin portions situated outside the rotor portion and having ends facing the inner peripheral surface of the housing, and
deformable portions formed at each of the fin portions for changing a distance between the end of each fin portion and the inner peripheral surface of the housing according to a resistance of the viscous fluid when the rotor is rotated, to thereby provide a resistance without being substantially affected by viscosity of the viscous fluid.

2. A damper according to claim 1, wherein said deformable portion is formed between fin portion and the rotor portion.

3. A damper according to claim 1, wherein said deformable portion is a leaf spring for connecting the rotor portion and the fin portion.

4. A damper according to claim 3, wherein said leaf spring is integrally formed with the rotor portion and the fin portion by insert molding.

5. A damper according to claim 1, wherein each of said fin portions has an arc face at the end thereof, said arc face having a curvature radius smaller than a radius of the inner peripheral surface of the housing, said curvature radius gradually decreasing toward outside from a center of the arc face.

6. A damper according to claim 1, wherein each of said fin portions includes projections at the end thereof projecting from top and bottom faces of the fin portion in an axial direction of the rotor portion.

7. A damper according to claim 1, wherein each of said deformable portion is formed such that upon rotation of the rotor portion, when the viscosity is low, the distance between the inner peripheral surface and the end of the fin portion is small, and when the viscosity is high, the distance between the inner peripheral surface and the end of the fin portion is large.

8. A damper according to claim 1, further comprising a cover member attached to the housing to retain the rotor portion between the cover member and the housing, said rotor portion having a shaft passing through the cover member.

9. A damper according to claim 8, wherein said housing is provided with a base for supporting the rotor portion and a first step outside the base, and said cover member is provided with a second step at an inner top surface thereof, said first step being away from the second step so that the fin portions rotate inside the housing with a substantially equal distance from the first step and the second step.

10. A damper according to claim 1, wherein each of said fin portions includes an extension portion as the end facing the inner peripheral surface of the housing, said extension portion changing a distance between the end of the extension portion and the inner peripheral surface of the housing according to a rotational direction of the rotor portion.

11. A damper, comprising:
a housing having a cylindrical shape and an inner peripheral surface,
viscous fluid filled in the housing,
a rotor portion rotatably supported inside the housing,
fin portions situated outside the rotor portion, and
extension portions provided at the fin portions, each extension portion being formed at one lateral side of each fin portion and having an end facing the inner peripheral surface of the housing for changing a distance between the end of the extension portion and the inner peripheral surface according to a rotational direction of the rotor portion.

12. A damper according to claim 11, wherein said fin portion includes projections at the end thereof projecting from top and bottom faces of the fin portion in an axial direction of the rotor portion.
